(19) United States
(12) Patent Application Publication
(10) Pub. No.: US 2008/0120241 A1
(43) Pub. Date: May 22, 2008

(54) Method and apparatus for reproducing discontinuous AV data

(75) Inventor: Su-hyun Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/717,016

(22) Filed: Mar. 13, 2007

(30) Foreign Application Priority Data
Nov. 16, 2006 (KR) 10-2006-0113387

(51) Int. Cl. H04L 9/00

(52) U.S. Cl. 705/59

(57) ABSTRACT

Provided is a method of sharing content to which digital rights management (DRM) is applied. In the method of sharing the content between a first device storing the content and a second device while they are connected, the first device receives a request for transmission of the content from the second device, determines whether it is connected to the second device and generates license information regarding the DRM, and transmits the license information and the content to the second device. Accordingly, content to which DRM is applied can be shared between a plurality of devices only when they are connected, thereby removing a need to redundantly purchase the DRM content and allowing the content to be conveniently shared. Also, since the content can be shared when the devices are physically connected, degradation of the quality of sound or interruptions can be minimized.

### CROSS-REFERENCE TO RELATED PATENT APPLICATIONS

This application claims priority from Korean Patent Application No. 10-2006-0113387, filed on Nov. 16, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to use of content to which Digital Rights Management (DRM) is applied, and more particularly, to sharing content between devices.

2. Description of the Related Art

The spread of the Internet and the advances in communication technologies allow various types of digital content to be produced, processed, and distributed. However, unlike analog data, digital content is likely to be illegally copied, since it can be losslessly copied, and easily reused, processed and distributed.

In particular, a distribution environment for digital content is expanded with association of networks, association of devices, or association of content and a service. That is, conventionally, content can be distributed via a personal computer (PC) connected to the Internet, but content have been distributed via home appliance or a mobile device, using digital broadcasting or home networking.

Accordingly, research into Digital Rights Management (DRM) is actively being conducted in order to protect content and content manufacturers from illegal copying of the content. Also, a large number of DRM-based services have been introduced but are very limited due to the absence of compatibility between different DRM systems.

FIG. 1 is a block diagram of a conventional system for allowing devices to share content to which DRM is applied. As illustrated in FIG. 1, the conventional system includes a server device 10, a first client device 20, and a second client device 30. The first and second client devices 20 and 30 must receive the content to which DRM is applied and license information thereof from the server device 10. That is, each of the first and second client devices 20 and 30 requests the server device 10 to transmit the content, and receives the license information and the content in order to share the content. Thus, even if the first client device 20 receives the content, the second client device 30 must receive the content from the server device 10 in order to reproduce the content in the second client device 30.

Also, when it is difficult to connect a client device to an external server device, it is difficult to losslessly receive, store, and reproduce content to which DRM is applied, even if the client device has good reproducing performance.

### SUMMARY OF THE INVENTION

The present invention provides a method of allowing devices to easily share content to which DRM is applied.

According to an aspect of the present invention, there is provided a method of allowing a first device, which stores content to which DRM is applied, to share the content with a second device while the first device is connected to the second device, the method comprising receiving a request for transmission of the content from the second device; determining whether the first device is connected to the second device, and generating license information regarding the DRM; and transmitting the license information and the content.

The transmitting of the license information and the content comprises receiving a request for transmission of the license information from the second device.

When the request for transmission of the license information is received from the second device, continuously generating the license information is continuously generated.

When the first device is disconnected from the second device, the transmitting of the license information and the content is discontinued.

A plurality of data blocks which are divided from the content, and temporary license information for decrypting the data blocks are transmitted to the second device.

According to another aspect of the present invention, there is provided a method of allowing a first device, which stores content to which DRM is applied, to share the content with a second device while the first device is connected to the second device, the method comprising requesting the first device to transmit the content, receiving license information regarding the DRM and the content from the first device, and reproducing the content.

The content is decrypted using the license information.

The license information corresponding to the reproduced content disappears.

The reproducing of the content comprises requesting the first device to transmit the license information.

A plurality of data blocks which are divided from the content, and temporary license information for decrypting the data blocks are received from the first device.

According to another aspect of the present invention, there is provided an apparatus comprising a content storage unit storing content to which DRM is applied; a channel interface receiving a request for transmission of the content from an external device while being connected to the external device; a license generating unit generating license information regarding the DRM; and a controller determining whether the channel interface is connected to the external device, and allowing the license information and the content to be transmitted to the external device via the channel interface.

According to another aspect of the present invention, there is provided a device comprising a channel interface requesting an external device to transmit content to which DRM is applied while being connected to the external device which stores the content, and receiving license information regarding the DRM and the content from the external device; an encrypting/decrypting unit decrypting the content by using the license information; and a content reproducing unit reproducing the decrypted content.

According to another aspect of the present invention, there is provided a content sharing system comprising a first device storing content to which DRM is applied, and generating license information regarding the DRM and transmitting the license information and the content when receiving a request for transmission of the content; and a second device requesting the first device to transmit the content and reproducing the content by using the received license information while being connected to the first device.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a conventional system for allowing devices to share content to which DRM is applied;

FIG. 2 is a block diagram of a system for allowing devices to share content to which DRM is applied, according to an embodiment of the present invention;

FIG. 3 is a block diagram of a first client device according to an embodiment of the present invention;

FIG. 4 is a block diagram of a second client device according to an embodiment of the present invention;

FIG. 5 is a flowchart illustrating a method of allowing devices to share content to which DRM is applied, according to an embodiment of the present invention;

FIG. 6A is a diagram illustrating the construction of the original content transmitted from a server device to a first client device, according to an embodiment of the present invention; and

FIG. 6B is a diagram illustrating the construction of content transmitted from a first client device to a second client device, according to an embodiment of the present invention.

### DETAILED DESCRIPTION OF THE INVENTION

Hereinafter, exemplary embodiments of the present invention will be described in detail with reference to the accompanying drawings.

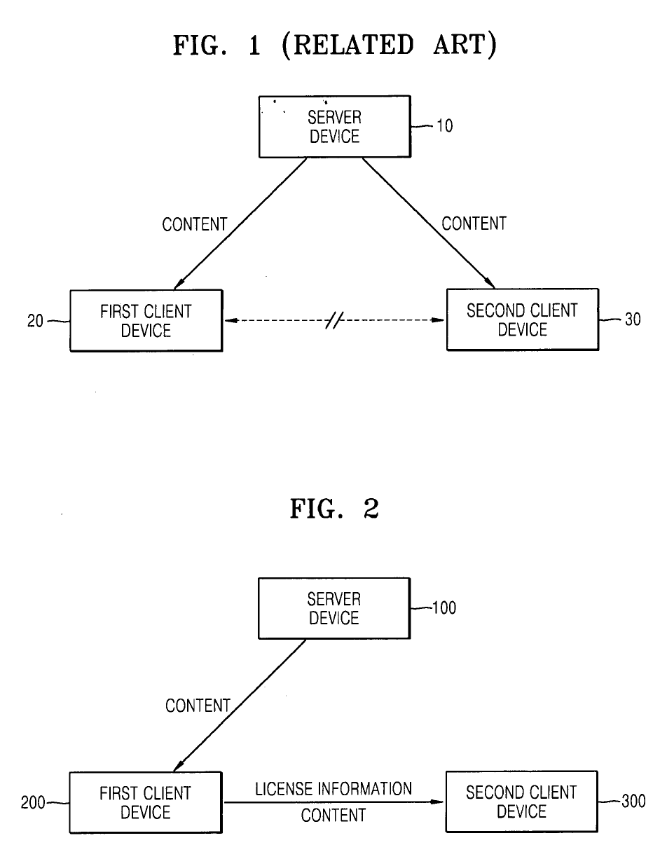

FIG. 2 is a block diagram of a block diagram of a system for allowing devices to share content to which DRM is applied. As illustrated in FIG. 2, the system includes a server device 100, a first client device 200, and a second client device 300.

For convenience of explanation, a device that receives content from the server device 100 and a device that receives the received content from the first client device 200 are set as the first client device 200 and the second client device 300, respectively. In some cases, both the first and second client devices 200 and 300 can be capable of transmitting and receiving content.

Also, the device that is set as the first client device 200 can perform the operation of the second client device 300, and the device that is set as the second client device 300 can perform the operation of the first client device 200.

First, it is assumed that the first client device 200 receives content to which DRM is applied from the server device 100, and stores it therein. If the first client device 200 is physically connected to the second client device 300, the first client device 200 transmits the stored content to which DRM is applied, and license information for decrypting encrypted content to the second client device 300 per a request for transmission of the content from the second client device 300.

In this case, the license information has temporary characteristics, since it is applied to only the DRM of the content to be transmitted and becomes unavailable once the content is reproduced. Thus, the second client device 300 continuously requests the first client device 200 to send the license information even during reproduction of the content.

When being physically connected to the first client device 200, the second client device 300 can receive the content and the license information thereof and reproduce the received content. If the physical connection is cancelled during reproduction of the content, the reproduction of the content is also discontinued.

The “physical connection” does not always indicate a state in which the first client device 200 and the second client device 300 are connected together but means that they are electrically connected.

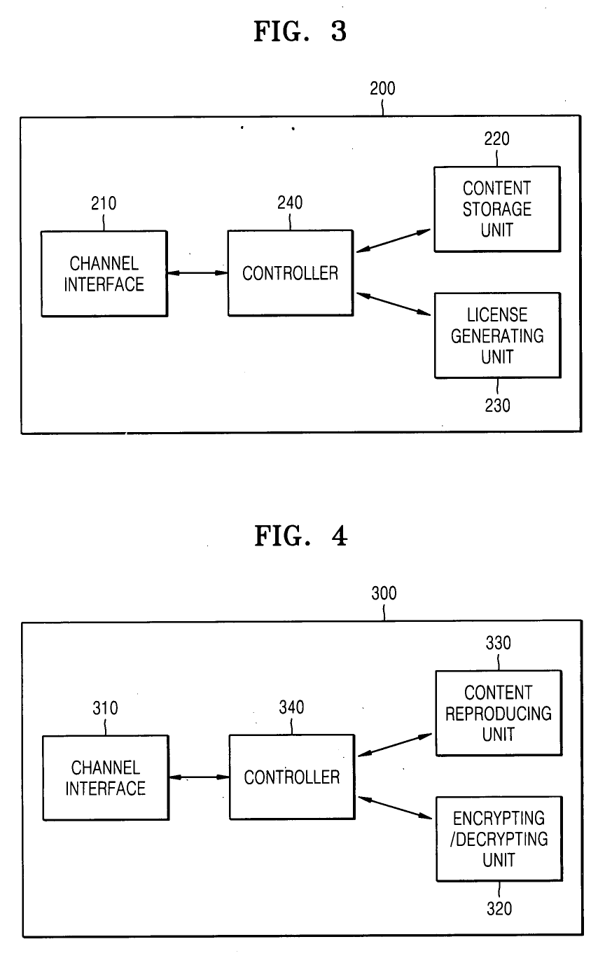

FIG. 3 is a block diagram of the first client device 200, illustrated in FIG. 2, according to an exemplary embodiment of the present invention. Referring to FIG. 3, the first client device 200 includes a channel interface 210, a content storage unit 220, a license generation unit 230, and a controller 240.

First, the channel interface 210 transmits various types of signals and information when the first client device 200 is physically connected to the server device 100 or the second client device 300. That is, the channel interface 210 receives a request for transmission of content from the second client device 300, and transmits the content and the license information thereof to the second client device 300.

The content storage unit 220 stores content, to which DRM is applied, which is received from the server device 100. In this case, the content to which DRM is applied may be limited by a usage duration, a reproduction frequency, and copying constraints.

The license generation unit 230 generates the license information containing a license key for decrypting the content to which DRM is applied, when the first client device 200 is connected to the second client device 300 and receives a request for transmission of content from the second client device 300.

The controller 240 controls the channel interface 210, the content storage unit 220, and the license generation unit 230, and discontinues the generating of the license information and the transmitting of the content when the first client device 200 is disconnected from the second client device 300.

FIG. 4 is a block diagram of the second client device 300, illustrated in FIG. 2, according to an exemplary embodiment of the present invention. Referring to FIG. 4, the second client device 300 includes a channel interface 310, an encrypting/decrypting unit 320, a content reproducing unit 330, and a controller 340.

First, the channel interface 310 requests the first client device 200 to transmit content and receives the content and license information thereof from the first client device 200 when the second client device 300 is physically connected to the first client device 200.

The encrypting/decrypting unit 320 decrypts the content to which DRM is applied, using the license information received from the first client device 200. Also, the encrypting/decrypting unit 320 may re-encrypt the content to which DRM is applied, and transmit the encrypted content to another client device.

The content reproducing unit 330 reproduces the content decrypted by the encrypting/decrypting unit 320.

The controller 340 controls the channel interface 310, the encrypting/decrypting unit 320, and the content reproducing unit 330, and allows a request for transmission of the content to be transmitted to the first client device 200 and the content and the license information to be received from the first client device 200, when the first client device 200 is connected to the second client device 300. Also, the controller 340 allows a request for transmission of the license information to the first client device 200 during reproduction of the decrypted content.

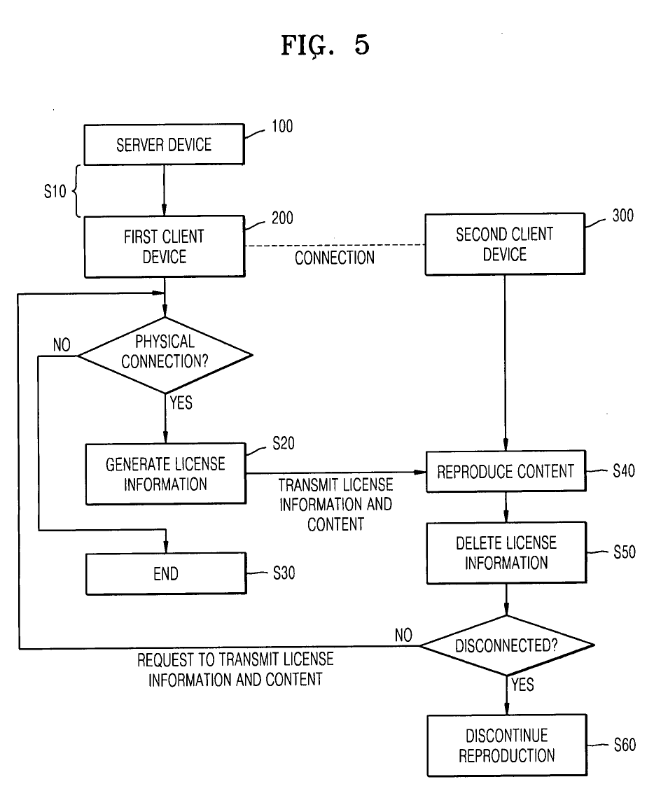

FIG. 5 is a flowchart illustrating a method of allowing devices to share content to which DRM is applied, according to an exemplary embodiment of the present invention.

First, it is assumed that the first client device 200 receives content to which DRM is applied from the server device 100, and stores it therein (S10). For convenience of explanation, in an exemplary embodiment of the present invention, it is assumed that DRM that can be reproduced only once is applied to the content.

When the first and second client devices 200 and 300 are physically connected, the license generating unit 230 of the first client device 200 generates license information containing a license key for decrypting the content (S20) and transmits the content to which DRM is applied and the generated license information to the second client device 300. If the first and second client devices 200 and 300 are not physically connected, the first client device 200 discontinues all operations (S30).

The second client device 300 decrypts the content to which DRM is applied by using the received license information so as to reproduce the content (S40).

In this case, reproduction of the content leads to automatic deletion of the license information regarding the reproduced content (S50). Thus, all license information are deleted when the content is completely reproduced once.

If the second client device 300 is disconnected from the first client device 200 during reproduction of the content, the reproduction of the content is discontinued (S60).

Also, when the connection of the second client device 300 to the first client device 200 is maintained during the reproduction of the content, the second client device 300 requests the first client device 200 to transmit the license information.

Accordingly, the first client device 200 receiving the request for transmission of the license information determines whether it is physically connected to the second client device 300 again, continuously generates the license information when the physical connection is maintained (S20), and transmits the generated license information to the second client device 300.

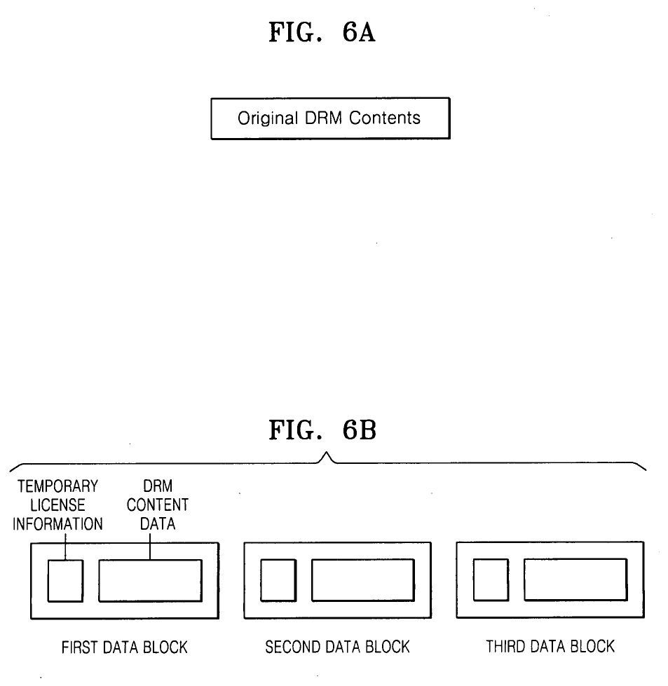

The first client device 200 may divide content, such as that illustrated in FIG. 6A, which is transmitted from the server device 100 to the first client device 200, into a plurality of data blocks as illustrated in FIG. 6B, and transmit them to the second client device 300.

FIG. 6A is a diagram illustrating the construction of the original DRM content transmitted from the server device 100 to the first client device 200. FIG. 6B is a diagram illustrating the construction of content transmitted from the first client device 200 to the second client device 300.

That is, in order to serve the convenience of data transmission and increase security, the first client device 200 may divide the original DRM content into a plurality of data blocks, encrypt them, and transmit the encrypted data blocks to the second client device 300.

As illustrated in FIG. 6B, the original DRM content is divided into a plurality of data blocks, and each of the data blocks contains DRM content data and temporary license information.

The temporary license information contains the result of encrypting the original license information that is transmitted from the server device 100 to the first client device 200. When the temporary license information is transmitted, temporary license keys for respectively decrypting the encrypted data blocks are also transmitted.

Also, the temporary license information may be differently set for each of the data blocks, and is deleted internally like the original license information once the content is reproduced.

Accordingly, the second client device 300 receives the temporary license information from the first client device 200 while receiving the encrypted content in the form of the plurality of the data blocks from the first client device 200, and decrypts the data blocks. Thus, the content can be reproduced after performing a two-step decoding process, thereby more significantly increasing security.

In an exemplary embodiment of the present invention, content is shared between the first client device 200 that receives the content directly from the server device 100, and the second client device 300, but can be shared between the second client device 300 and another device, as described above.

Accordingly, according to an exemplary embodiment of the present invention, content and license information are transmitted from the first client device 200 that stores content to the second client device 300 only when the first client device 200, and the second client device 300 are physically connected, thereby allowing the second client device to reproduce the content within a limited amount of time.

The method of sharing content between devices according to the present invention can be embodied as a computer program. Code and code segments of the program may be easily derived by computer programmers skilled in the technical field to which the invention pertains. The program may be stored in a computer readable medium, and read and executed by a computer to perform the method. Examples of the computer readable medium include a magnetic recording medium, an optical recording medium, or even carrier waves.

As described above, in the method of sharing content to which DRM is applied, according to the present invention, the content can be shared only when a plurality of devices are connected, thereby removing a need to redundantly purchase the DRM content and allowing the content to be conveniently shared. Further, since the content is shared when the devices are physically connected, it is possible to minimize degradation of the quality of sound or interruptions, caused by the connection.

While this invention has been particularly shown and described with reference to exemplary embodiments thereof, it will be understood by those skilled in the art that various changes in form and details may be made therein without departing from the spirit and scope of the invention as defined by the appended claims.

1. A method of allowing a first device, which stores content to which digital rights management (DRM) is applied, to share the content with a second device while the first device is connected to the second device, the method comprising:
receiving a request for transmission of the content from the second device;
determining whether the first device is connected to the second device, and generating license information regarding the DRM; and
transmitting the license information and the content.

2. The method of claim 1, wherein the transmitting of the license information and the content comprises receiving a request for a transmission of the license information from the second device.

3. The method of claim 2, wherein, if the request for transmission of the license information is received from the second device, the license information is continuously generated.

4. The method of claim 3, wherein, if the first device is disconnected from the second device, the transmitting of the license information and the content is discontinued.

5. The method of claim 1, wherein a plurality of data blocks representing the content, and temporary license information for decrypting the plurality of data blocks are transmitted to the second device.

6. A method of allowing a first device, which stores content to which digital rights management (DRM) is applied, to share the content with a second device while the first device is connected to the second device, the method comprising:
requesting the first device to transmit the content;
receiving license information regarding the DRM and the content from the first device; and
reproducing the content.

7. The method of claim 6, wherein the content is decrypted using the license information.

8. The method of claim 7, wherein the license information corresponding to the reproduced content is deleted.

9. The method of claim 6, wherein the reproducing of the content comprises requesting the first device to transmit the license information.

10. The method of claim 6, wherein a plurality of data blocks of the content, and temporary license information for decrypting the data blocks are received from the first device.

11. An apparatus comprising:
a content storage unit which stores content to which digital rights management (DRM) is applied;
a channel interface which receives a request for transmission of the content from an external device while being connected to the external device;
a license generating unit which generates license information regarding the DRM; and
a controller which determines whether the channel interface is connected to the external device, and allows the license information and the content to be transmitted to the external device via the channel interface.

12. The apparatus of claim 11, wherein the channel interface receives a request for transmission of the license information from the external device while transmitting the license information and the content.

13. The apparatus of claim 12, wherein the controller allows the license information to be continuously generated when receiving the request for transmission of the license information from the external device.

14. The apparatus of claim 13, wherein, if the channel interface is disconnected from the external device, the transmission of the license information and the content is discontinued.

15. A device comprising:
a channel interface which requests an external device to transmit content to which digital rights management (DRM) is applied while being connected to the external device which stores the content, and receives license information regarding the DRM and the content from the external device;
an encrypting/decrypting unit which decrypts the content by using the license information; and
a content reproducing unit which reproduces the decrypted content.

16. The device of claim 15, further comprising a controller which requests the external apparatus to transmit the license information during the reproduction of the decrypted content.

17. The device of claim 16, wherein the license information corresponding to the reproduced content is deleted.

18. The device of claim 17, wherein the encrypting/decrypting unit re-encrypts the content by using the license information.

19. A content sharing system comprising:
a first device which stores content to which digital rights management (DRM) is applied, and generates license information regarding the DRM and transmits the license information and the content when receiving a request for transmission of the content; and
a second device which requests the first device to transmit the content and reproduces the content by using the received license information while being connected to the first device.

20. The content sharing system of claim 19, wherein, if the first device is disconnected from the second device, the transmission of the content and the license information and the reproduction of the content are discontinued.

21. A computer readable medium having recorded thereon a computer program for executing the method of claim 1.
